(19) United States
(12) Patent Application Publication
(10) Pub. No.: US 2010/0122627 A1
(43) Pub. Date: May 20, 2010

(54) MEMBRANE-BASED SYSTEMS AND METHODS FOR HYDROGEN SEPARATION

(76) Inventors: Joseph Michael Schwartz, Williamsville, NY (US); Raymond Francis Drnevich, Clarence Center, NY (US); Jerome Thomas Jankowiak, Williamsville, NY (US); Dante Patrick Bonaquist, Grand Island, NY (US)

Correspondence Address: PRAXAIR, INC.;LAW DEPARTMENT - M1 557, 39 OLD RIDGEBURY ROAD, DANBURY, CT, 06810-5113, US

(21) Appl. No.: 12/270,890

(22) Filed: Nov. 14, 2008

(51) Int. Cl. B01D 46/46; B01D 53/22

(52) U.S. Cl. 95/15; 96/4

(57) ABSTRACT

According to some embodiments, a method and a system are provided to receive hydrogen at a first pressure at a first side of a membrane, receive hydrogen at a second pressure from a second side of the membrane, combine the hydrogen received from the second side of the membrane with a purge stream to produce a permeate stream at the second pressure, and separate hydrogen from the permeate stream at a third pressure. The purge stream is associated with a phase transition temperature range.

### TECHNICAL FIELD

The present disclosure generally relates to hydrogen separation, as may be implemented by a hydrogen separator.

### BACKGROUND

Synthesis gas (“syngas”) is a gas mixture that contains varying amounts of carbon monoxide and hydrogen. Syngas may be generated from solid and liquid carbonaceous fuels, such as coal, coke, and liquid hydrocarbon feeds. For example, syngas may be generated by heating carbon-containing (i.e., carbonaceous) fuels in a gasification reactor with reactive gases, such as air or oxygen, often in the presence of steam and or water.

Syngas may include a pure gas component and a mixed gas component. To recover the pure gas component, a separation process first separates the pure gas component from the mixed gas component. In conventional membrane systems, the pure gas component is recovered at a low pressure while the mixed gas component is recovered at a high pressure.

For example, syngas may include hydrogen (i.e., a pure gas component) and carbon dioxide (i.e., a mixed gas component). Conventional membrane systems may be used to separate the hydrogen from the carbon dioxide, by allowing small molecules (i.e., hydrogen) to pass while preventing larger molecules (i.e., carbon dioxide) from passing. Using conventional membrane systems, the separated hydrogen typically exhibits a disadvantageously low pressure. In this regard, hydrogen, like some other pure gas components, cannot be easily used, stored or transported at low pressures. Accordingly, any hydrogen separated by conventional membrane systems must be compressed prior to being used, stored or transported.

### SUMMARY

A method and a system may be provided to receive hydrogen at a first pressure at a first side of a membrane, receive hydrogen at a second pressure from a second side of the membrane, combine the hydrogen received from the second side of the membrane with a purge stream to produce a permeate stream at the second pressure, and separate hydrogen from the permeate stream at a third pressure. The purge stream is associated with a phase transition temperature range.

The claims are not limited to the disclosed embodiments, however, as those in the art can readily adapt the description herein to create other embodiments and applications.

### BRIEF DESCRIPTION OF THE DRAWINGS

The construction and usage of embodiments will become readily apparent from consideration of the following specification as illustrated in the accompanying drawings, in which like reference numerals designate like parts.

FIG. 1 is a flow diagram of a process according to some embodiments.

FIG. 2 is a block diagram of a system according to some embodiments.

FIG. 3 is a flow diagram of a process according to some embodiments.

FIG. 4 is a block diagram of a system according to some embodiments.

FIG. 5 is a block diagram of a system according to some embodiments.

FIG. 6 is a block diagram of a system according to some embodiments.

FIG. 7 is a block diagram of a system according to some embodiments.

FIG. 8 is a block diagram of a system according to some embodiments.

FIG. 9 is a block diagram of a system according to some embodiments.

FIG. 10 is a block diagram of a system according to some embodiments.

FIG. 11 is a block diagram of a system according to some embodiments.

### DETAILED DESCRIPTION

The following description is provided to enable any person in the art to make and use the described embodiments and sets forth the best mode contemplated by for carrying out the described embodiments. Various modifications, however, will remain readily apparent to those in the art.

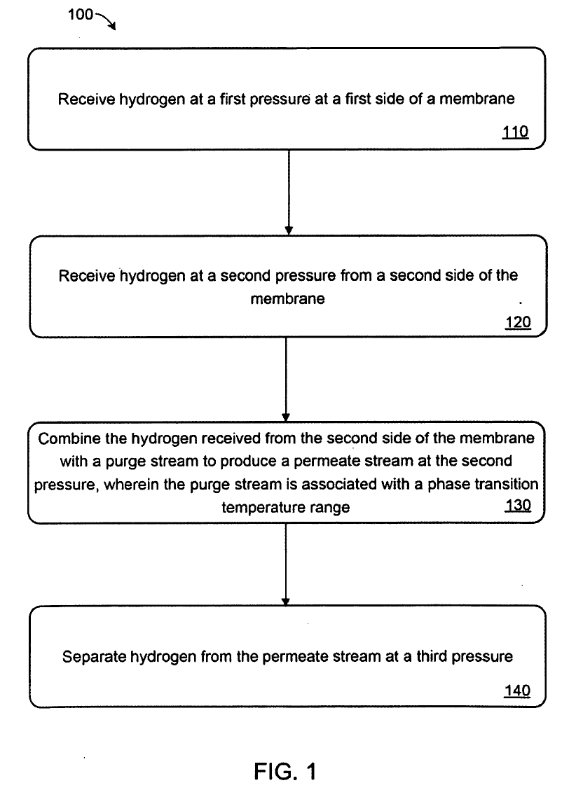

Now referring to FIG. 1, an embodiment of a process 100 is illustrated. Process 100 may be performed by any suitable system that is or becomes known. At 110, hydrogen is received at a first pressure at a first side of a membrane. The hydrogen (i.e., symbol H on the periodic table) may be contained within a hydrocarbon-based material or any material that includes hydrogen. In some embodiments, the first side of the membrane may allow the hydrogen at the first pressure (e.g., in a gaseous state) to permeate through the membrane.

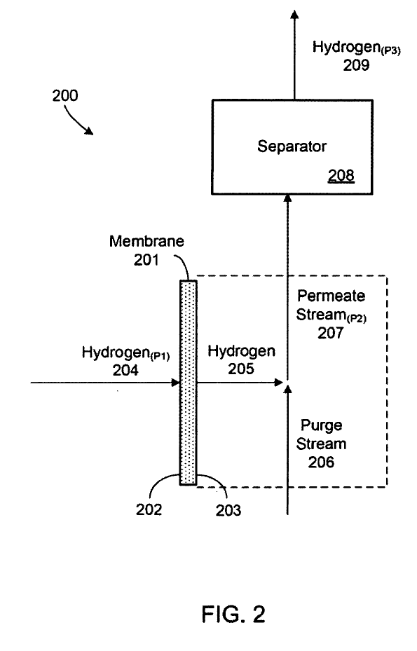

FIG. 2 is a block diagram of system 200 for performing process 100 according to some embodiments. As mentioned above, embodiments are not limited to system 200 or, for that matter, to process 100. System 200 includes membrane 201, having first side 202 and second side 203. Membrane 201 may comprise a high-temperature hydrogen transport membrane as is understood in the art. At 110, first side 202 may receive hydrogen 204 at a first pressure. The first pressure is denoted P1 in FIG. 2.

Referring back to FIG. 1, hydrogen is received at a second pressure from a second side of the membrane at 120. According to the FIG. 2 example, hydrogen 205 is received at a second pressure from second side 203 at 120. As shown, the second pressure is denoted P2. In some embodiments, a conduit (i.e., dashed line) into which hydrogen 205 is received exhibits a higher pressure than partial pressure P1 of hydrogen 204. Therefore, the second pressure P2 may be greater than the first pressure P1. The conduit may comprise any suitable tube, channel, or enclosure.

Next, at 130, the hydrogen received from the second side of the membrane is combined with a purge stream to produce a permeate stream at the second pressure. FIG. 2 illustrates hydrogen 205 combining with purge stream 206 to produce permeate stream 207. In keeping with the above-described notation, FIG. 2 also indicates that a pressure of permeate stream 207 is equal to P2. It should be noted that the FIG. 2 diagram is schematic and is not intended to specify or require any particular physical configuration. For example, purge stream 206 may impact side 203 of membrane 201 in some embodiments.

In some embodiments, a temperature of the permeate stream may be at least one hundred degrees Celsius. The purge stream may comprise one or more materials that are heated and pressurized to a gaseous state. The materials of the purge stream may depend on a type of membrane used, a membrane operating temperature and pressure, and/or a chemical composition of the permeate stream. For example, purge stream materials that may be used during hydrogen recovery in conjunction with palladium-alloy membranes include hydrocarbons between about C₆H₁₄ and C₁₀H₂₂. In some embodiments in which a hydrocarbon and a palladium membrane are used, the hydrocarbon may comprise a saturated hydrocarbon because the palladium membrane may act as a hydrogenation catalyst if exposed to the hydrocarbon at elevated temperature and for long exposure times. In some embodiments, other materials with critical temperatures between approximately 100° C. and 400° C. and critical pressures below approximately 40 bar can also be used as purge stream materials provided that they do not react with hydrogen, have a low vapor pressure at a separator (see below) temperature of approximately 100-200° F., and are stable in a hydrogen environment. Purge material selection may be based on a tradeoff between lower volatilities of heavier materials and lower critical temperatures and decomposition rates of lighter materials. In some embodiments, lighter hydrocarbons may require less energy input while yielding lower hydrogen purity, and may exhibit lower decomposition rates.

In some embodiments, the purge stream may comprise a supercritical fluid or a condensable multi-component mixture. For example, the purge stream may comprise octane, a mixture of octane and steam, and/or one or more of the following fluids: 1,2,3-trichoropropane, 2,4-dimethylpentane, 2-methyl-3-ethylpentanetrimethyl borate, 3,3-dimethylpentane, 3-methyl-3-ethylpentane, 1-chlorobutane, 3-ethylpentane, 2,2,3,3-tetramethylbutane, 2-chlorobutane, 2,2,3-trimethylbutane, 1-octanoltert-butyl chloride, 1-heptanol, 2-octanol, 1-pentanol, 1,1-dimethylcyclohexane, 2-methyl-3-heptanol, 2-methyl-1-butanol, 1,2-dimethylcyclohexane, 4-methyl-3-heptanol, 3-methyl-1-butanol, 1,3-dimethylcyclohexane, 5-methyl-3-heptanol, 2-methyl-2-butanol, 1,4-dimethylcyclohexane, 2-ethyl-1-hexanol, 2,2-dimethy, 1-1-propanolethylcyclohexanen-propylcyclohexaneperfluorocyclohexane, 1,1,2trimethylcyclopentane, isopropylcyclohexane, perfluoro-n-hexane, 1,1,3-trimethylcyclopentane, n-nonaneperfluoro-2-methylpentane, 1,2,4-trimethylcyclopentane, 2-methyloctane, perfluoro-3-methylpentane, 1-methylethylcyclopentane, 2,2-dimethylheptane, perfluoro-2,3-dimethylbutanenpropylcyclopentane, 2,2,3-trimethylhexane, methylcyclopentane, isopropylcyclopentane, 2,2,4-trimethylhexane, n-hexanecyclooctane, 2,2,5-trimethylhexane, 2-methyl pentane, n-octane, 3,3-diethylpentane, 3-methyl pentane, 2-methylheptane, 2,2,3,3-tetramethylpentane, 2,2-dimethyl butane, 3-methylheptane, 2,2,3,4-tetramethylpentane, 2,3-dimethyl butane4-methylheptane, 2,2,4,4-tetramethylpentane, perfluoromethylcyclohexane, 2,2-dimethylhexane2,3,3,4-tetramethylpentane, perfluoro-n-heptane, 2,3-dimethylhexanel-nonanolcycloheptane, 2,4-dimethylhexane, Butylcyclohexane, 1,1-dimethylcyclopentane, 2,5-dimethylhexane, isobutylcyclohexane, 1,2-dimethylcyclopentane, 3,3-dimethylhexanesec-butylcyclohexane, methylcyclohexane, 3,4-dimethylhexane, tert-butylcyclohexane, n-heptane, 3-ethylhexanen-decane, 2-methylhexane, 2,2,3-trimethylpentane, 3,3,5-trimethylheptane, 3-methylhexane, 2,24-trimethylpentane, 2,2,3,3-tetramethylhexane, 2,2-dimethylpentane, 2,3,3-trimethylpentane, 2,2,5,5-tetramethylhexane, 2,3-dimethylpentane, or 2,3,4-trimethylpentane.

At 140 of process 100, hydrogen is separated from the permeate stream at a third pressure. Separating the hydrogen from the permeate stream may comprise condensing substantially all of the purge stream from the permeate stream by cooling the permeate stream to a liquid state. For example, separator 208 of system 200 may receive permeate stream 207 and separate hydrogen 209 (at pressure P3) therefrom. According to some embodiments, separator 208 may cool permeate stream 207 by using a chiller, by using one or more heat exchangers to exchange the heat of permeate stream 207 with cooler streams, or by combinations thereof.

The purge stream, such as purge stream 206 of FIG. 2, may comprise one or more components such that when the purge stream 206 is heated, or cooled, purge stream 206 may transition from a liquid state to a gaseous state (or vice versa) over a temperature range (i.e., a phase transition temperature range) instead of at a discrete phase transition temperature. Therefore, in order to separate the hydrogen from the permeate stream at 140, the permeate stream may be cooled below a critical temperature of at least one of the one or more components of the purge stream.

In some embodiments, the second pressure may be substantially equal to the third pressure. However, in some embodiments, the third pressure may be slightly less than the second pressure. In particular, while the purge stream may exhibit a temperature above the critical temperature/pressure of at least one of its constituent purge stream materials, the separator may operate below the critical temperature/pressure of the purge stream.

If the separator operates below the critical temperature as described above, the purge stream may be condensed and removed from the permeate stream at 140. The resulting hydrogen may therefore be recovered at the higher pressure associated with the purge stream even though the hydrogen's partial pressure on the first side of the membrane is comparatively low. Recovery of hydrogen at the higher pressure may reduce a cost of hydrogen compression compared to conventional low pressure recovery systems.

A multi-component purge stream may enhance heat exchange efficiency because the purge stream does not exhibit a discrete phase transition temperature, but rather a phase transition temperature range (i.e., the latent heat is spread out over a range of temperatures). This temperature range is based on the individual components contained in the purge stream.

Moreover, by maintaining the purge stream above the critical temperature and pressure, much less (ideally, no) discrete latent heat remains to be recovered by heat exchangers. Therefore, the energy required for the phase change is spread out over a temperature range, and heat may be continuously transferred from a higher-temperature permeate stream to the lower-temperature purge stream.

Over time, some of the purge stream may leave a system, either through leaks or through remaining as a vapor and being carried off with a hydrogen product. If a multi-component purge stream is used, different components may exhibit different volatilities, and lighter components may leave the system at a higher rate than heavier components. Therefore, a composition of a multi-component purge stream may change over time and careful analysis may be required to determine which components must be added to maintain a desired purge stream composition.

In a case of a supercritical or single-component purge stream, the composition of the purge stream does not change. Accordingly, only a pressure of the purge stream may need to be monitored to detect decomposition of the purge material. When decomposition occurs, molecules of the purge stream may become lighter than the original purge material, so there is a probability that the decomposition products will leave with the hydrogen product. Decomposition may also occur when mixtures are used because mixtures are likely to include at least one hydrocarbon larger than the single-component supercritical stream, and because decomposition rates may increase as a hydrocarbon size increases. In some embodiments, an adsorbent or cooler may be added to a separator outlet to remove any trace hydrocarbons in the separated hydrogen that result from decomposition or volatility.

When an expensive membrane is used, such as one made from palladium, it may be desirable to minimize a membrane area to reduce costs. In one embodiment, a need for membrane area may be reduced by increasing a flow rate of the purge stream. The flow rate of the purge stream may depend on a cost of providing and circulating additional purge material and heat, and a capital cost of using the additional membrane area. However, increasing the flow rate of the purge stream may also increase an amount of fuel consumed and thus a purge flow rate may be based on membrane size costs, fuel costs, and desired hydrogen recovery.

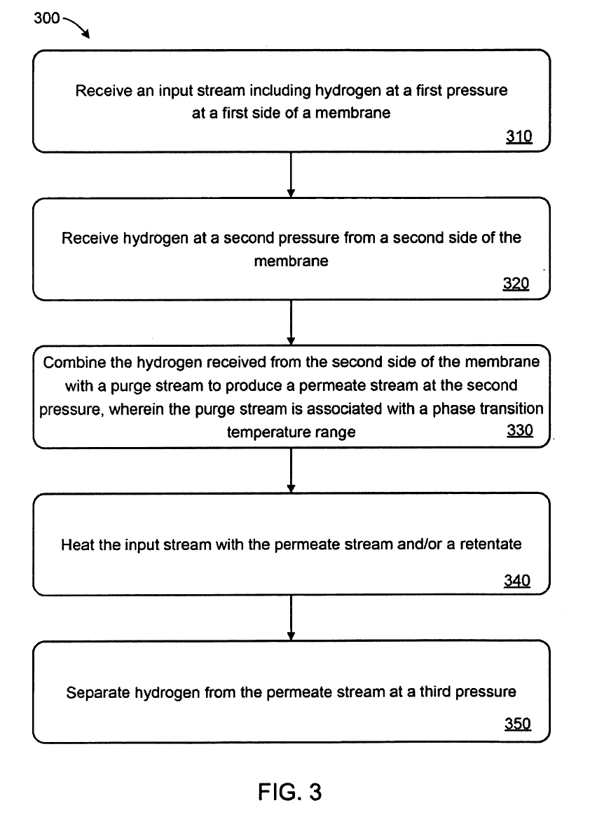

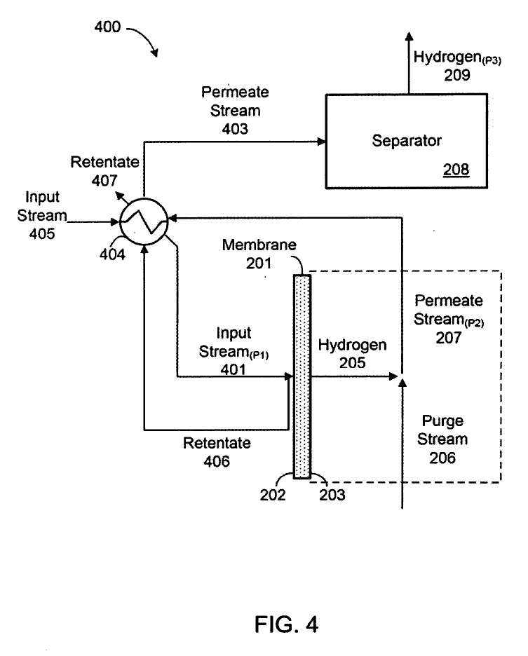

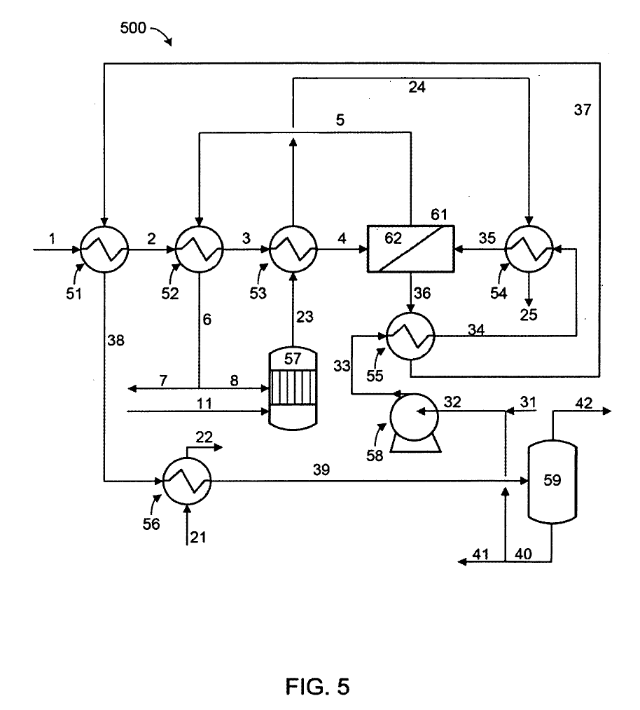

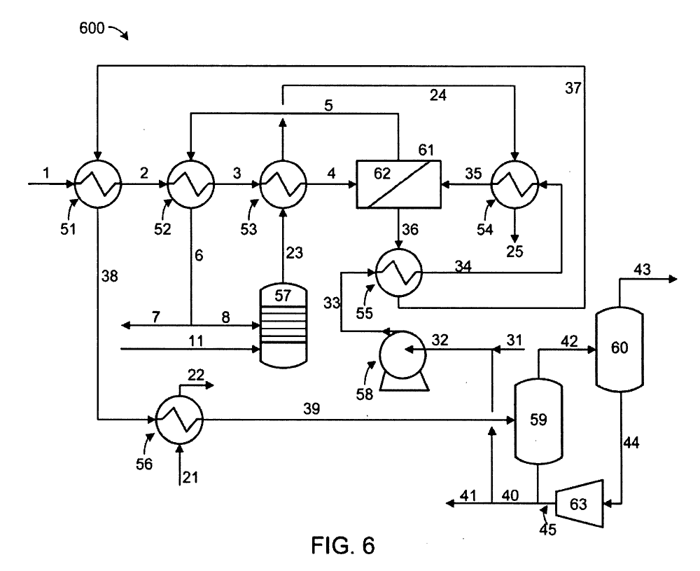

Now referring to FIG. 3, an embodiment of a process 300 is shown. Process 300 may be performed by a system such as, but not limited to, system 400 of FIG. 4, the system of FIG. 5 or the system of FIG. 6.

An input stream that includes hydrogen is initially received at a first side of a membrane at 310. The input stream exhibits a first pressure, as illustrated, for example, by input stream_{(P1)} 401 of FIG. 4. Steps 320 through 350 of process 300 may proceed as described above with respect to steps 120 through 140 of process 100. FIG. 4 depicts hydrogen 205, purge stream 206, permeate stream 207 and separator 208, each of which may operate and be composed as described above.

However, at 340, the input stream is heated with the permeate stream and/or with a retentate. Turning to the first alternative, separator 208 may separate an output permeate stream 403 of FIG. 4 at 350. Permeate stream 403 may be virtually identical to purge stream 206, albeit at a different temperature and/or pressure.

FIG. 4 shows heat exchanger 404 receiving permeate stream 207. As shown, heat exchanger 404 may use the heat of permeate stream 207 to heat input stream 405. Retentate 406 represents a remainder of input stream 401 after removal of hydrogen 205. Heat exchanger 404 may also or alternatively use the heat of retentate 406 to heat input stream 405. After being cooled, the retentate 406 results in cooled retentate 407.

FIG. 5 is a diagram of system 500, which may implement an embodiment of process 300. FIG. 5 shows input feed 1 at a first temperature and heated via heat exchanger 51, resulting in first heated input feed 2 exhibiting a second temperature greater than the first temperature. First heated input feed 2 may then be heated a second and a third time by a series of heat exchangers such as heat exchanger 52 and heat exchanger 53, which produce, in turn, second heated input feed 3 and third heated input feed 4. In some embodiments, third heated input feed 4 exhibits an at least partially-gaseous state.

Membrane housing 61, including membrane 62, may receive third heated input feed 4 comprising a material that includes hydrogen. The hydrogen permeates through membrane 62 while the remainder of third heated input feed 4, now depleted of hydrogen (i.e., retentate 5), does not pass through membrane 62. The hydrogen received from the second side of membrane 62 may be combined with purge stream 35 to produce permeate stream 36 at a second pressure.

Retentate 5 is fed into heat exchanger 52, thereby heating first heated input feed 2 to an at least partially-gaseous state (i.e., second heated input feed 3) and cooling retentate 5 to produce cooled retentate 6. As illustrated, cooled retentate 6 may be split such that first portion 7 of cooled retentate 6 is returned to a process from where it originated (not shown in FIG. 5) and second portion 8 of cooled retenate 6 may be burned along with oxygen-containing gas 11 in a reactor or burner 57 to produce hot gas 23. Burner 57 may comprise an oxidation reactor, or a catalytic partial oxidation (“CPOX”) reactor for syngas production. However, in some embodiments, burner 57 may comprise a steam reformer, an autothermal reformer, an oxygen-based partial oxidation reactor, or an oxygen transport membrane reactor.

Hot gas 23 may be fed into heat exchanger 53 to exchange heat with second heated input feed 3, thereby producing third heated input feed 4 and first cooled gas 24. In some embodiments, heat from a permeate stream, such as permeate stream 36 of FIG. 5, may be exchanged with a purge stream, such as purge stream 33, to heat the purge stream and to cool the permeate stream so that the permeate stream may be separated into a purge stream and hydrogen. For example, permeate stream 36 may be fed into heat exchanger 55, where heat from permeate stream 36 is exchanged with cooler purge stream 33 (which is below its critical temperature), thereby producing hotter purge stream 34 and cooler permeate 37. Heat exchanger 51 may use permeate 37 to heat input feed 1. Heated purge stream 34 may then be heated above its critical temperature via first cooled gas 24 at heat exchanger 54.

Permeate stream 38, having been cooled by heat exchanger 51, is further cooled by heat exchanger 56 below its dew point to create permeate stream 39. Heat exchanger 56 may be cooled by cooling water that is input via cooling water input 21 and is output from heat exchanger 56 via cooling water output 22. Permeate stream 39, now cooled to a gas-liquid stream, may be received at separator 59 to separate the permeate stream 39 into hydrogen product 42 and liquid purge stream 40. In some embodiments, a portion 41 of liquid purge stream 40 may be removed.

Liquid purge stream 40 may be combined with fresh purge material 31 to provide purge stream 32 to pump 58. Pump 58 may overcome a pressure drop in order to maintain the flow of purge stream 32. In some embodiments, a temperature of now-pressurized purge stream 33 may be below a critical temperature of the purge material.

In some embodiments, one or more of the heat exchangers may be located in proximity to membrane 62 to heat a stream received by heat exchanger 53 beyond its typical temperature. This additional heat may be transferred across membrane 62 to purge stream 35 to heat the purge stream 35 to a higher temperature, such as a membrane operating temperature. Heating purge stream 35 to a higher temperature may eliminate a need for heat exchanger 54, which may reduce a cost of the system without sacrificing performance or efficiency.

Depending on a particular process and a size of the process, a heat exchanger may not be capable of transferring enough heat to justify a capital cost of the heat exchanger. In this situation, extra heat may be provided by burning additional retentate or fuel and accepting a small loss in efficiency to reduce a capital cost.

In some embodiments of FIG. 5, some of purge stream 35 may exit system 500 with the hydrogen product stream. This may occur in a case that purge stream 35 comprises a light hydrocarbon purge stream.

To prevent the loss of purge steam 35, second separator 60 and compressor or pump 63 are included in system 600 of FIG. 6. The elements of system 600 may be implemented as described above with respect to similarly-numbered elements of system 500. In some embodiments, second separator 60 may comprise an adsorption unit, a cooler or a chiller such as a glycol chiller.

Second separator 60 may receive hydrogen product stream 42 from first separator 59 and further chill hydrogen product stream 42 to output higher-purity hydrogen product 43 and sweep gas 44. Sweep gas 44 may be compressed by compressor or pump 63 and then added to liquid purge stream 40. In some embodiments, if the second separator 60 comprises an adsorption unit, then the compressor or pump 63 comprises a compressor.

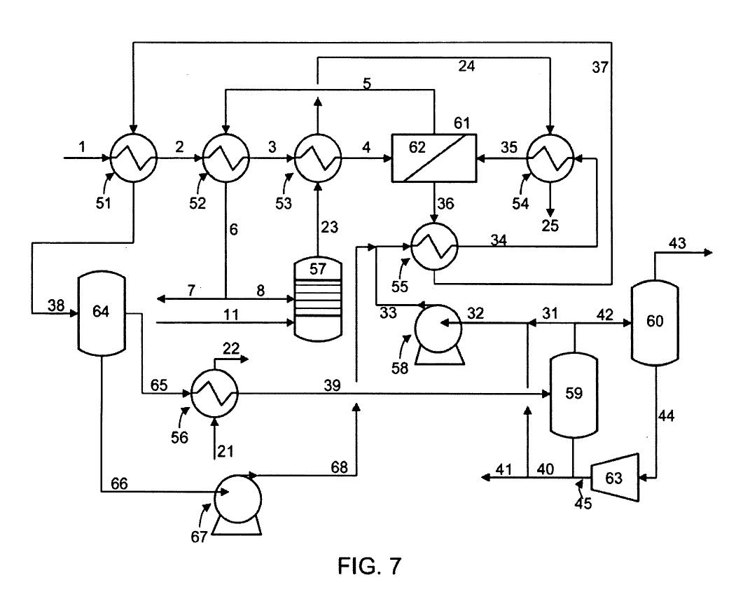

Now referring to FIG. 7, system 700 may comprise an embodiment of one or more processes described herein. The elements of system 700 may be implemented as described above with respect to similarly-numbered elements of system 500. System 700 may further comprise third separator 64 and second pump 67. As stated previously, hydrogen may be separated from permeate stream 37 by cooling permeate stream 37 to a temperature that results in condensation of a desired portion of the liquid purge material. The liquid purge material may be recycled at the cooler temperature, while a vapor component may be further cooled at heat exchanger 56 to remove the remaining purge material. This process may reduce the cooling energy required by removing a significant portion of purge material at a higher temperature prior to the final separation step.

As illustrated in FIG. 7, separator 64 receives permeate stream 38. Separator 64 separates permeate stream 38 into vapor component 65 and liquid component 66/68. Vapor component 65 may be further cooled by heat exchanger 56. Liquid component 68 may be pumped via second pump 67 to a pressure equal to the purge steam 34 and is combined with purge stream 34. In some embodiments, liquid component 68 may be combined with purge stream 33 depending on a temperature of the liquid component 68.

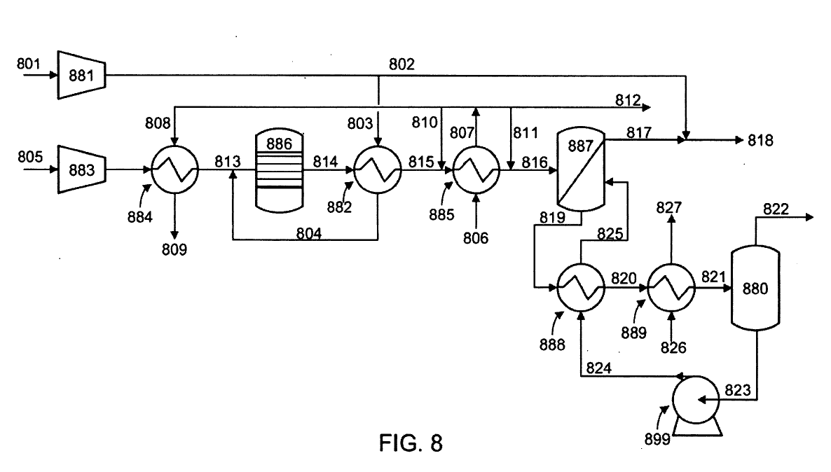

FIG. 8 illustrates system 800 according to some embodiments of process 100. As illustrated in FIG. 8, first gas 801, such as, but not limited to, natural gas, may be compressed by first compressor 881. A first portion 803 of the compressed gas may be heated via heat exchanger 882 to produce heated first gas 804 and may then be fed into reactor 886. A second portion 802 of the compressed gas may be combined with output 817 of membrane reactor 887 (i.e., a combination of a membrane and a reactor) to form combination output 818.

For example, in some embodiments, compressor 881 may compress 86,700 lb/hr (about 2 million scfh) of natural gas to 470 psig. About 75%, or 66,100 lb/hr, of the compressed natural gas may go directly to a gas turbine (not shown). The remaining 20,600 lb/hr of the compressed natural gas may be heated by heat exchanger 882 to produce hot natural gas at about 1000° F., which may be fed into reactor 886.

A second gas 805, such as, but not limited to, air, may be compressed by second compressor 883. The compressed air may be heated at heat exchanger 884 and then combined with heated first gas 804. Heat exchanger 884 may also receive steam 808 (a portion of steam 807) to heat second gas 805, the steam having been created by water 806 from a water inlet (not shown) that was brought to a boil at heat exchanger 885. The cooled steam becomes a condensate stream 809 which may be recycled back to the water inlet. Any remaining steam 810/811 may be injected into a syngas or may be exported to an external system 812.

For example, and in some embodiments, 1.14 million scfh of air may be compressed to 470 psig using a compressor and heated to 590° F. in a heat exchanger. 35,800 lb/hr of water is boiled in heat exchanger to produce steam. 5600 lb/hr of steam may be used to preheat the air in a heat exchanger, resulting in condensate stream. In this example, 16,900 lb/hr of steam may be exported to a steam turbine or to any other application.

First gas 803 and second gas 805 may be heated in separate heat exchangers (i.e., heat exchanger 882 and heat exchanger 884, respectively) such that mixture 813 of the heated gasses enters reactor 886 at a temperature exceeding 700° F. In some embodiments, the temperature may be substantially 775° F. A higher preheat temperature may reduce an amount of air necessary for reactor 886 to function and thus may reduce an amount of combustion required to heat reactor 886. Reactor 886 may operate at a temperature of substantially 1700° F. and may convert first gas 803 and second gas 805 into a third gas. For example, natural gas and air may be converted into syngas.

Reactor 886 may output a material that comprises hydrogen 814. For example, the product of reactor 886 may comprise 2.11 million scfh of syngas that contains 31% H₂, 16% CO, and 6% CH₄, with a balance composed mainly of CO₂, N₂, and H₂O. The material comprising hydrogen 814 may be cooled in heat exchanger 882 and mixed with steam 810 to cool syngas 815 prior to entering heat exchanger 885. The cooled syngas 816 may be mixed with steam 811 after exiting heat exchanger 885. The mixture of steam and cooled syngas may be input into an integrated membrane/shift reactor 887. For example, syngas 816 may exit the heat exchanger at approximately 440° F. and may be mixed with about 10,500 lb/hr of steam before entering integrated membrane/shift reactor 887. In some embodiments, a shift reactor may convert CO and steam into CO₂ and hydrogen. The integrated membrane/shift reactor may operate in a range of about 600-650° F.

The integrated membrane/shift reactor may receive purge stream 825 that receives permeated (i.e., recovered) hydrogen to form permeate stream 819. In some embodiments, the membrane of integrated membrane/shift reactor 887 may remove 761,000 scfh of hydrogen using a supercritical octane purge of 2 million scfh, representing 85% hydrogen recovery.

Permeate stream 819 may be cooled in heat exchanger 888 by heating cooled liquid 824, such as, but not limited to, octane. In some embodiments, the purge stream may gain additional heat in the integrated membrane shift reactor 887 due to an exothermic water gas shift reaction. Permeate stream 820 may be further cooled at heat exchanger 889 to produce permeate stream 821. Heat exchanger 889, in turn, may be cooled by cooling water 826, thereby creating steam 827. If permeate stream 819 comprises octane, then the octane may be condensed by being cooled in the heat exchanger 889 against cooling water 826. The cooled permeate stream 820 becomes permeate stream 821, which may be separated in separator 880 to remove hydrogen product 822 from liquid product 823. Liquid product 823 may be recycled to pump 899, and recycled liquid 824 may cool heat exchanger 888.

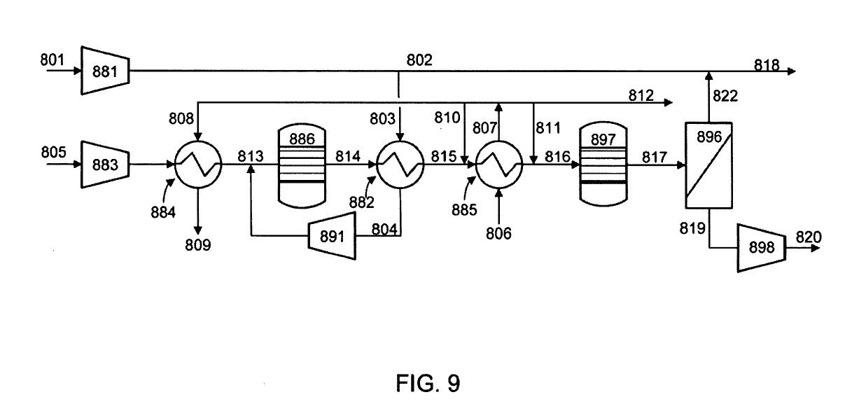

FIG. 9 illustrates a system 900 according to some embodiments of process 100. The elements of system 900 may be similar to similarly-numbered elements of system 800, and may further comprise shift reactor 897, membrane 896 and third compressor 898.

As illustrated in FIG. 8, the shift reactor and hydrogen membrane may be integrated in a same unit. When separated as shown in system 900, membrane 896 may be downstream of shift reactor 897. In some embodiments, an integrated membrane and shift reactor will produce more hydrogen than a standalone shift reactor and standalone membrane. However, if these elements are separated, it may be possible to run the separate elements in different conditions. For example, a single membrane module could be changed without shutting down the entire process. In this case, power generation may continue by feeding a fuel, such as natural gas 802, around the process.

Compressor 898, as illustrated, may receive hydrogen product output 819. The compressor 898 may provide an alternative to the purge process as described with respect to FIG. 8. In some embodiments, separating the two processes allows membrane 896 to operate at a cooler temperature. In this regard, a non-palladium membrane, such as, but not limited to, a molecular sieving membrane, may be used at such lower temperatures. Molecular sieve membranes may separate hydrogen based on molecular size and may be more robust than palladium membranes, particularly in harsh environments. For example, sulfur may contaminate palladium membranes, while molecular sieve membranes may be more resistant to sulfur contamination.

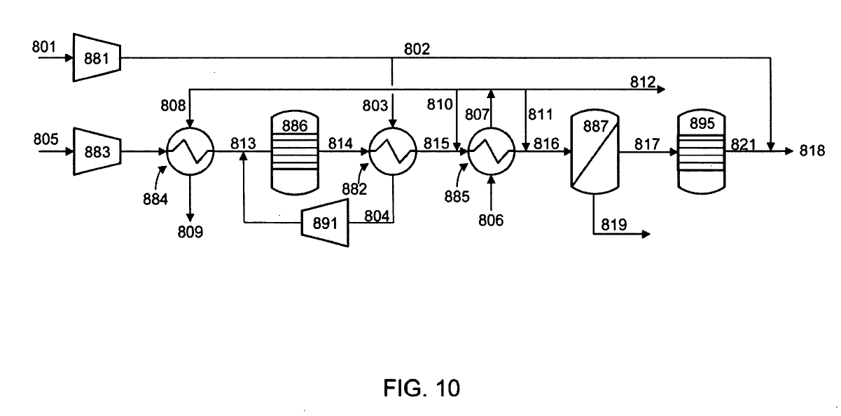

In some embodiments, a high pressure retentate stream may be used as a fuel source for a gas turbine. Pressure energy stored in the pressurized retentate stream may be used to produce power by blending a fuel, such as natural gas, with the pressurized retentate stream. In some embodiments, a hydrogen content of fuel for a turbine is 10% or less. Since some hydrogen membrane processes may produce a retentate stream including more than 10% hydrogen, blending the retentate with natural gas may not only increase a heating value of the fuel but may also reduce the hydrogen content. In some embodiments, a methanation reactor may be used to convert hydrogen in the retentate and carbon oxides to methane. FIG. 10 illustrates system 1000 according to some of such embodiments. System 1000 may be similar to system 800 and system 900, and may further comprise methanator 895.

Methanator 895 may convert output 817 of shift reactor 887 to methane, which may reduce a requirement for natural gas to dilute the hydrogen concentration of fuel going to a gas turbine (not shown). Methanator 895 may also enable the use of more natural gas in reactor 886, which may increase hydrogen production 819. In some embodiments, a portion of the output of shift reactor 887 may be methanated while a second portion of the output may bypass methanator 895. Bypassing a portion of the output may reduce a size and cost of methanator 895.

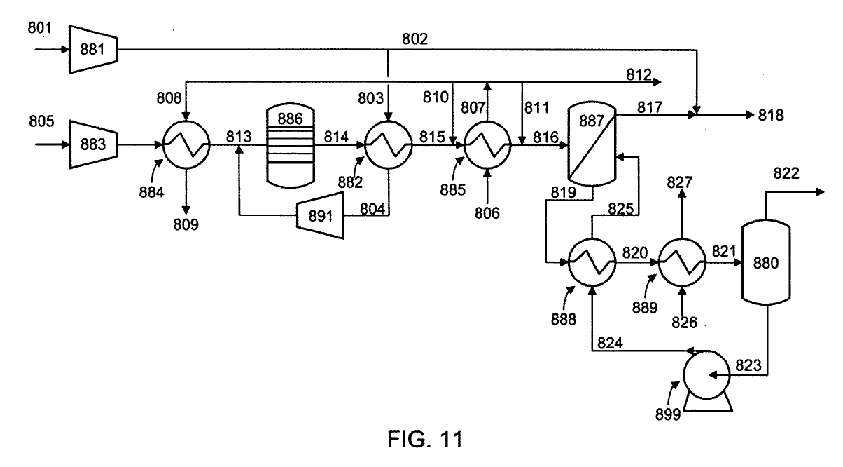

FIG. 11 illustrates system 1100 according to some embodiments of process 100. System 1100 comprises system 800 with the addition of booster compressor 891. Booster compressor 891 may compress gas 804, such as, but not limited to, natural gas. Compressed gas 804 may be fed to reactor 886 so that a resulting stream 817 may exhibit a same pressure as supplemental natural gas that may be fed to an output of the system. Booster compressor 891 may add equivalent pressure to overcome a pressure drop associated with gas 805 traversing through system 1100.

In some embodiments, gas 801 comprises light hydrocarbons, liquids, or mixtures of light hydrocarbons and liquids. Gas 805 may comprise oxygen or air. In some embodiments, oxygen may be obtained through a ceramic oxygen transport membrane (“OTM”) operating at high temperature. The heat for the OTM may be produced by combustion for the turbine or oxidation reactions occurring in reactor 886. In some embodiments, the OTM may be integrated into the reactor 886, which may significantly increase a heating value of reactor product 814, so less natural gas would be required for blending. Reactor product 814 may contain a higher fraction of hydrogen, so it would be possible to recover more hydrogen using the membrane.

In some embodiments, water may be directly fed into the syngas 815/816. This process may quench syngas 815/816 and vaporize the water before entering shift reactor 887. Steam may also be added either upstream (steam 810) or downstream (steam 811) of heat exchanger 885. Adding steam upstream may reduce an inlet temperature to heat exchanger 885, which may simplify the material requirements and reduce capital cost. By adding steam downstream, more steam may be produced in heat exchanger 885 due to a higher inlet temperature. Steam may also be fed into a reactor to produce additional reforming in the reactor and increase a hydrogen/CO ratio, which may increase a hydrogen concentration and partial pressure at a membrane inlet (where flux is the highest). Adding steam to the reactor may also reduce a required conversion where the reactor is a shift reactor. Placement of steam 810/811 may be based on a determination of an actual pressure and temperature of export steam, an amount of exported steam desired, the capital cost of the heat exchangers, and relative values or power, natural gas, and hydrogen.

Those in the art will appreciate that various adaptations and modifications of the above-described embodiments can be configured without departing from the scope and spirit of the claims. Therefore, it is to be understood that the claims may be practiced other than as specifically described herein.

What is claimed is:

1. A method comprising:
receiving hydrogen at a first pressure at a first side of a membrane;
receiving hydrogen at a second pressure from a second side of the membrane;
combining the hydrogen received from the second side of the membrane with a purge stream to produce a permeate stream at the second pressure, wherein the purge stream is associated with a phase transition temperature range; and
separating hydrogen from the permeate stream at a third pressure.

2. The method of claim 1, wherein the second pressure is greater than the first pressure, and wherein the first pressure is a hydrogen partial pressure at the first side of the membrane.

3. The method of claim 1, wherein a temperature of the permeate stream is at least one hundred degrees Celsius and wherein the membrane comprises a high-temperature hydrogen transport membrane.

4. The method of claim 1, wherein a retentate from the membrane is fed to a gas turbine, wherein the retentate results from extraction of the received hydrogen at the first pressure at the first side of the membrane from an input stream including the hydrogen at the first pressure.

5. The method of claim 1, wherein separating the hydrogen from the permeate stream comprises:
condensing substantially all of the purge stream from the permeate stream by cooling the permeate stream via (i) one or more heat exchangers or (ii) a chiller.

6. The method of claim 1, wherein the purge stream comprises one or more components, and wherein separating the hydrogen from the permeate stream comprises cooling the purge stream below a critical temperature of at least one of the one or more components.

7. The method of claim 1, further comprising:
recapturing heat from the permeate stream.

8. The method of claim 7, wherein recapturing the heat comprises:
exchanging heat from the permeate stream with an input stream including the hydrogen at the first pressure via one or more heat exchangers, wherein a temperature of the permeate stream is greater than a temperature of the input stream.

9. The method of claim 7, wherein recapturing the heat comprises:
exchanging heat from the permeate stream with the purge stream via one or more heat exchangers, wherein a temperature of the permeate stream is greater than a temperature of the purge stream.

10. The method of claim 1, wherein the purge stream comprises a supercritical fluid.

11. The method of claim 1, wherein the purge stream comprises a condensable multi-component mixture.

12. The method of claim 1, wherein the purge stream is not associated with a discrete phase transition temperature.

13. The method of claim 1, wherein the second pressure is greater than the first pressure, and wherein the second pressure is substantially equal to the third pressure.

14. The method of claim 1, further comprising: recapturing heat from a retentate stream, wherein the retentate stream results from extraction of the received hydrogen at the first pressure at the first side of the membrane from an input stream including the hydrogen at the first pressure.

15. The method of claim 14, wherein recapturing the heat comprises:
receiving the input stream including the hydrogen at the first pressure;
exchanging heat from the retentate stream with the input stream via one or more heat exchangers, wherein a temperature of the retentate stream is greater than a temperature of the input stream.

16. A system comprising:
a membrane to receive hydrogen at a first pressure at a first side of a membrane and to output hydrogen at a second pressure from a second side of the membrane;
a conduit in which the outputted hydrogen is to be combined with a purge stream to produce a permeate stream at the second pressure, wherein the purge stream is associated with a phase transition temperature range; and
a separator to separate hydrogen from the permeate stream at a third pressure.

17. The system of claim 16, wherein the second pressure is greater than the first pressure and wherein the second pressure is substantially equal to the third pressure.

18. The system of claim 16, wherein the membrane comprises a high-temperature hydrogen transport membrane, and wherein a temperature of the permeate stream is at least one hundred degrees Celsius.

19. The system of claim 16, wherein the purge stream comprises one or more components, and wherein the separator is to cool the purge stream below a critical temperature of at least one of the one or more components.

20. The system of claim 16, further comprising:
one or more heat exchangers to exchange heat from the permeate stream with (i) a hydrocarbon-based material or (ii) the purge stream.
